(19) United States
(12) Patent Application Publication
(10) Pub. No.: US 2002/0066610 A1
(43) Pub. Date: Jun. 6, 2002

(54) Electric scooter providing improved layout of battery set

(76) Inventor: Shui-Te Tsai, Chang Hua (TW)

Correspondence Address: BROWDY AND NEIMARK, P.L.L.C., 624 NINTH STREET, NW, SUITE 300, WASHINGTON, DC, 20001-5303, US

(21) Appl. No.: 09/729,789

(22) Filed: Dec. 6, 2000

(51) Int. Cl. B62M 7/00

(52) U.S. Cl. 180/220; 180/65.1; 180/68.5; 280/87.05

(57) ABSTRACT

An electric scooter comprises a footboard on which a folding device, and a driving device are mounted. A steering tube is fastened with the footboard and the folding device. A front wheel is pivoted to the bottom end of the steering tube. A rear wheel is pivoted to the rear end of the footboard such that the rear wheel is driven by the driving device. A battery set is removably fastened with the folding device such that the battery set is located in a receiving space formed between the footboard and the steering tube which is in a folding state.

### FIELD OF THE INVENTION

The present invention relates generally to an electric scooter, and more particularly to a battery mount of the electric scooter.

### BACKGROUND OF THE INVENTION

As shown in FIGS. 1 and 2, a conventional electric scooter is provided with a battery set 60, which is mounted on a footboard 10 of the conventional electric scooter. The distance H1 between the top of the battery set 60 and the ground surface raises the center of gravity of a rider who stands on the top of the battery set 60. In order to provide a remedy to correct such a safety hazard as described above, the battery set 60 is mounted on the rear end of the footboard 10, as shown in FIG. 2. The front end of the battery set 60 and the folding device 20 of the electric scooter are separated by a distance P1, which is too short to accommodate the foot of a rider. In addition, the battery set 60 hinders the folding of the scooter. Such a battery set mounting means as described above is further defective in design in that it does not make it easy for a person to change the battery of the battery set 60.

### SUMMARY OF THE INVENTION

The primary objective of the present invention is to provide an electric scooter with a bettery set which does not interfere with the operation of the electric scooter.

It is another objective of the present invention to provide an electric scooter with a battery set which does not hinder the folding of the electric scooter.

It is still another objective of the present invention to provide an electric scooter with a battery set capable of protecting the battery against impact.

In keeping with the principle of the present invention, the foregoing objectives of the present invention are attained by an electric scooter comprising a footboard, a folding device, a steering handlebar, a front wheel, a rear wheel, a driving device, and a battery set. The steering handlebar is fastened at one end with the front end of the footboard. The folding device is fastened with the footboard and the steering handlebar. The front wheel is pivotally fastened with the bottom end of the steering handlebar. The rear wheel and the driving device are mounted at the rear end of the footboard such that the rear wheel is driven by the driving device. The battery set is fastened with the folding device. The footboard has a substantial room to accommodate the foot of a rider.

### BRIEF DESCRIPTION OF THE DRAWINGS

FIG. 1 shows a side schematic view of a prior art electric scooter.

FIG. 2 shows a side schematic view of another prior art electric scooter.

FIG. 3 shows a side schematic view of an electric scooter of the present invention.

FIG. 4 shows a side schematic view of the electric scooter of the present invention in the folded state.

FIG. 5 shows a schematic view of a second preferred embodiment of the present invention.

FIG. 6 shows a sectional view taken along the direction indicated by a line 6-6 as shown in FIG. 5.

FIG. 7 shows a schematic view of a third preferred embodiment of the present invention.

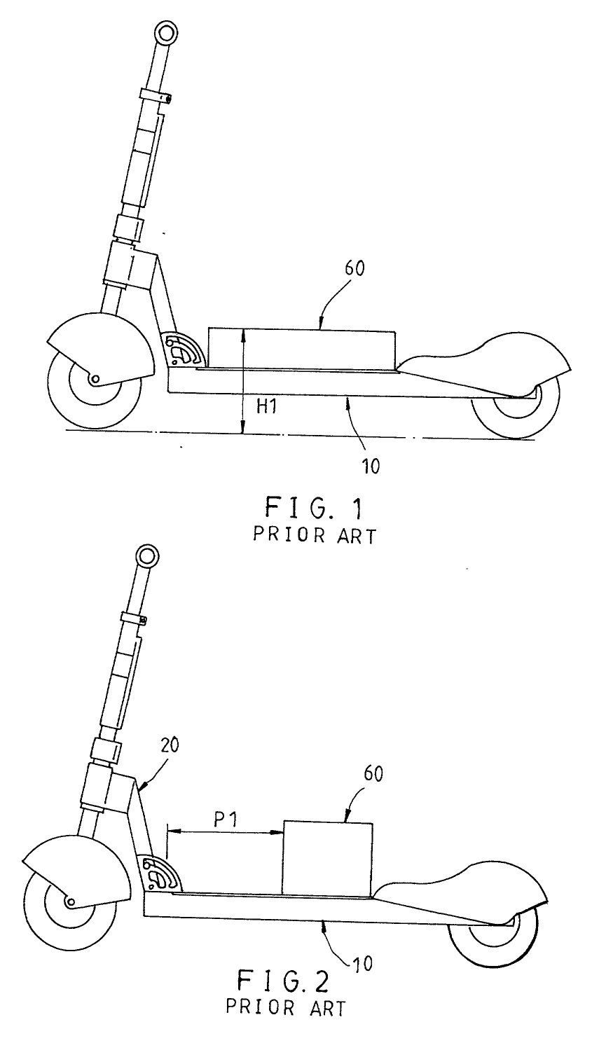

### DETAILED DESCRIPTION OF THE INVENTION

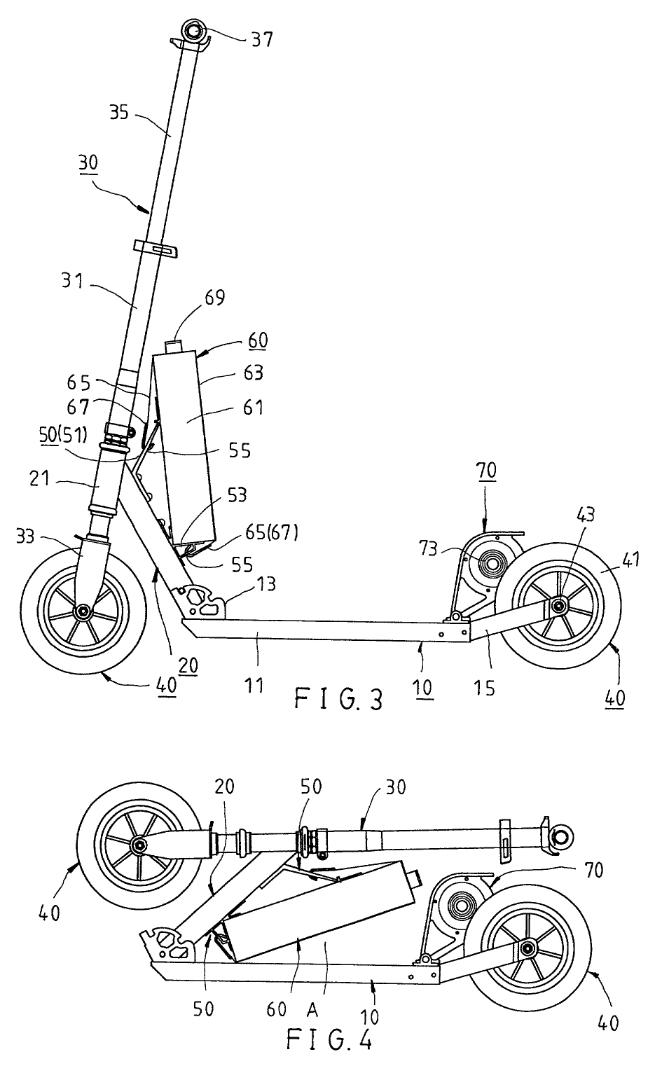

As shown in FIGS. 3 and 4, an electric scooter 1 embodied in the present invention comprises the component parts which are described hereinafter.

A footboard 10 has a board 11, a folding seat 13 fastened at the front end of the board 11, and a rear wheel pivoting portion 15 fastened at one end with the rear end of the board 11.

A folding device 20 is fastened at one end with the folding seat 13, and at other end with a shaft tube 21.

A steering tube 30 has a tubular body 31, which is received at one end thereof in the shaft tube 21 such that tubular body 31 is fastened with a front wheel pivoting portion 33 for pivoting a front wheel 40. The steering tube 30 is provided at the top end of an expandable tube 35 thereof with two handlebars 37, and a switch (not shown in the drawings).

A rear wheel 40 has a wheel body 41 which is fastened pivotally with the pivoting portion 15 by a pivot 43.

A support frame 50 is used to fix the folding device 20 and is formed of a hanging portion 51 and a support portion 53 having a plurality of hook holes 55.

A battery set 60 has a battery 61, which is housed in a container 63, a plurality of lashing straps 65 and hooks 67, and a handle 69.

A motor 70 is mounted on the rear end of the footboard 10 and is provided with a drive wheel 73 for driving the rear wheel 40. The battery set 60 is the power source of the motor 70.

As shown in FIG. 4, the electric scooter 1 of the present invention is folded by the folding device 20 such that the steering tube 30 is parallel to the footboard 10, and that a receiving space A is available between the steering tube 30 and the footboard 10 for accommodating the battery set 60.

In light of the battery set 60 being removably supported by the support frame 50, the battery set 60 can be easily removed from the electric scooter 1 of the present invention, so as to facilitate the replacing of battery.

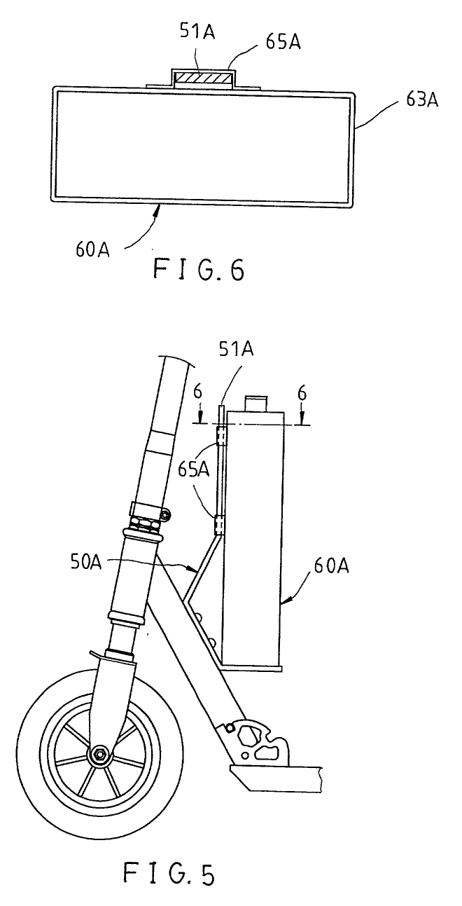

As shown in FIGS. 5 and 6, the second preferred embodiment of the present invention comprises a battery set 60A. The battery set 60A has a container 63A which is provided with two lugs 65A and is supported by a support frame 50A in such a manner that a hanging portion 51A of the support frame 50A is put through the lugs 65A of the container 63A.

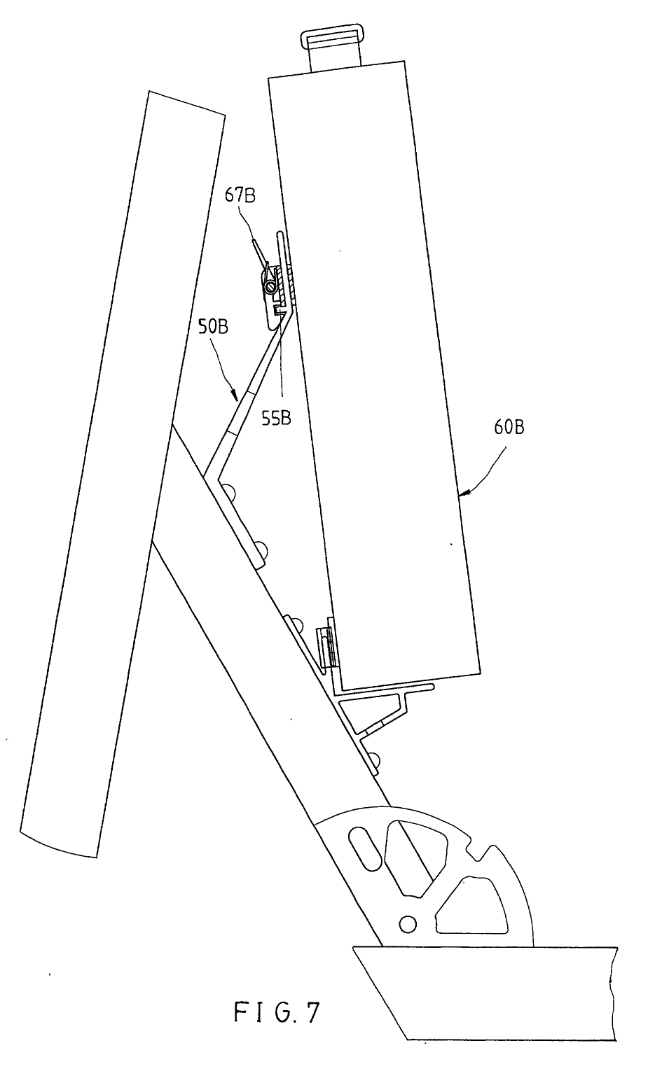

As shown in FIG. 7, the third preferred embodiment of the present invention comprises a support frame 50B and a battery set 60B. The support frame 50B is provided with a retaining portion 55B. The battery set 60B is provided with a retaining member 67B and is supported by the support frame 50B such that the retaining member 67B is retained by the retaining portion 55B.

What is claimed is:

1. An electric scooter comprising:
a footboard;
a folding device fastened pivotally to a front end of said footboard;
a steering tube pivoted to said folding device;
a front wheel pivoted to a bottom end of said steering tube;
a rear wheel pivoted to a rear end of said footboard;
a driving device mounted on said footboard to drive said rear wheel; and
a battery set removably mounted on said folding device such that said battery set is located in a receiving space formed between said footboard and said steering tube which is in a folding state.

2. The electric scooter as defined in claim 1, wherein said folding device is provided with a support frame; wherein said battery set is mounted on said support frame.

3. The electric scooter as defined in claim 2, wherein said support frame is provided with a hanging portion for holding said battery set.

4. The electric scooter as defined in claim 3, wherein said battery set is provided with at least one lug for said hanging portion of support frame to put through.

5. The electric scooter as defined in claim 3, wherein said support frame is provided with a retaining portion; wherein said battery set is provided with a retaining member which is retained by said retaining portion of said support frame.

6. The electric scooter as defined in claim 2, wherein said support frame is provided with a support portion for supporting the bottom of said battery set.

7. The electric scooter as defined in claim 1, wherein said battery set is fastened with one or more lashing straps.

8. The electric scooter as defined in claim 1, wherein said battery set is housed in a container.

9. The electric scooter as defined in claim 1, wherein said battery set is provided with a handle to facilitate the carrying of said battery set.
